(19) United States
(12) Patent Application Publication
(10) Pub. No.: US 2006/0077856 A1
(43) Pub. Date: Apr. 13, 2006

(54) Optical information recording apparatus and optical information reproducing apparatus

(75) Inventor: Katsumi Mizunoe, Yokohama-shi (JP)

Correspondence Address: KODA & ANDROLIA, 2029 CENTURY PARK EAST, SUITE 1140, LOS ANGELES, CA, 90067, US

(73) Assignee: Optware Corporation

(21) Appl. No.: 11/201,248

(22) Filed: Aug. 9, 2005

(30) Foreign Application Priority Data
Aug. 12, 2004 (JP) 2004-235105

(51) Int. Cl. G11B 7/00

(52) U.S. Cl. 369/112.01; 369/112.23; 369/44.11

(57) ABSTRACT

Provided are a first moving unit 2a which, as an unit, moves an objective lens 23 and a relay lens 19 on the objective lens side out of a pair of relay lenses to an irradiation position of a recording medium 51, and a second moving unit 2b which moves a pair of reflectors 15, 17 as a unit.

### BACKGROUND OF THE INVENTION

1. Field of the Invention

The present invention relates to an optical information recording apparatus and an optical information reproducing apparatus utilizing holography and, more particularly, to an optical information recording apparatus and an optical information reproducing apparatus in which an objective lens is moved to make an access to a prescribed recording position or reproducing position of a recording medium.

2. Description of the Related Art

Conventionally, holographic recording which records information to a recording medium by utilizing holography is performed, in general, by making information light carrying image information which constitutes recording light and recording reference light overlap with each other inside the recording medium, and writing an interference pattern generated thereby to the recording medium. For reproducing the recorded information, reproduction reference light is irradiated to the recording medium so as to reproduce the image information by means of diffraction by the interference pattern (see Patent Document 1).

Recently, volume holography, especially digital volume holography, has been developed for achieving super high-density optical recording and has drawn an attention. The volume holography is a system which writes interference patterns three-dimensionally by actively utilizing the thickness direction of a recording medium. It is characterized as being able to improve the diffraction efficiency by increasing the thickness and to increase the recording capacity using multiple recording. The digital volume holography, while using similar recording media and recording system as those of the volume holography, is a holographic recording system directed to computers, in which image information to be recorded is limited to binary digital patterns. In this digital volume holography, image information such as an analog picture is digitized once and developed to two-dimensional digital pattern information which is recorded as the image information. At the time of reproduction, the digital pattern is read out and decoded so as to restore it as the original image information for display. With this, it becomes possible to reproduce the information which is extremely faithful to the original by performing deferential detection, error correction by coding the binary data, etc. even though SN ratio (signal-to-noise ratio) is somewhat bad at the time of reproduction.

An effective system for holographic recording is a system using an optical pickup device which comprises an optical system for recording information to a recording medium and for reproducing information from a recording medium by employing a disc-type recording media like CD (Compact Disc), DVD (Digital Versatile Disc), etc.

An optical pickup device in a conventional optical information recording/reproducing apparatus comprises: a light source for emitting a light flux; an information light generating means which generates information light carrying information by spatially modulating the light flux emitted from the light source; a recording reference light generating means which generates recording reference light using the light flux emitted from the light source; a reproduction reference light generating means which generates reproduction reference light using the light flux emitted from the light source; a recording/reproducing optical system which irradiates the information light and the recording reference light to a information recording layer so that the information is recorded to the information recording layer of the recording medium by an interference pattern generated by the interference between the information light and the recording reference light and also irradiates reproduction reference light to the information recording layer, and collects reproduction light generated from the information recording layer by irradiation of the reproduction reference light; and a detecting means for detecting the reproduction light which is collected by the recording/reproducing optical system (Patent Document 1: Japanese Patent Unexamined Publication 11-311938 (see claim 17)).

The conventional optical information recording/reproducing apparatus disclosed in the above-mentioned Patent Document 1 performs slide-servo by moving the entire optical pickup device in the radius direction of the recording medium in order to perform recording or reproduction at a prescribed recording position or reproduction position. However, the optical pickup device includes a light source, an information light generating means, a recording reference light generating means, a reproduction reference light generating means, a recording/reproducing optical system, and a detecting means so that the volume thereof is large and the weight is heavy. Therefore, a driving means for driving the optical pickup device becomes large-scaled and the optical information recording/reproducing apparatus also becomes large-scaled as a result.

Further, in the conventional optical information recording/reproducing apparatus, the optical pickup device is heavy and there is inertia working. Thus, the optical pickup device can not be accessed to the recording medium at a high speed thereby deteriorating the transfer rate.

Conventionally, in a CD drive and a DVD drive as optical information recording/reproducing apparatuses which do not utilizes holography, in order to reduce the volume of the part to be moved and to lightened the weight, an objective lens is separated from the light-source side and moved to be aligned with the irradiation position of the recording medium. This is possible in the CD drive and the DVD drive since it is only necessary that the optical system enables to transmit the intensity (energy) of the light.

However, the optical system of the holographic recording/reproduction irradiates the information light which is spatially modulated and the recording reference light to the recording medium by the objective lens, and records for causing interference in the information recording layer of the recording medium. Thus, it is necessary at least to form an image of the information light which is spatially modulated by a spatial light modulator (information expressing means). Also, at the time of reproduction, it is necessary at least to form an image in a detecting means finally. Said image is an image of the reproduction light generated from the information recording layer of the recording medium by the reproduction reference light, and is in an exit pupil plane of the objective lens.

Therefore, a pair of relay lenses having an equal focal distance f are provided, an image displayed in the spatial light modulator (information expressing means) is formed in an entrance pupil plane of the objective lens, and an image reproduced in the exit pupil plane of the objective lens is formed in the detecting means. In other words, it is an optical system of 4f type in which the first relay lens is disposed at a position away from the spatial light modulator (information expressing means) and the detecting means by a focal distance f, the second relay lens is disposed at a position away from the first relay lens by twice the focal distance f, and the objective lens is disposed such that the entrance pupil plane comes at a position away from the second relay lens by the focal distance f.

In this holographic recording/reproduction, if the objective lens is separated to be moved as employed conventionally in the case of the CD drive and the DVD drive which do not utilize holography, the position of the entrance pupil plane of the objective lens is also moved. Thus, the distance between the objective lens and the second relay lens changes as well.

FIG. 4 is an illustration for showing an optical system which is required in the case where the position of a spatial light modulator (information expressing means) and that of a detecting means 101 in a holographic recording optical system are fixed and the position of an objective lens 109 is moved. In FIG. 4, a recording medium 111 has a cross section in the radius direction and there is a rotation center of the recording medium 111 on the right side of FIG. 4.

As shown in FIG. 4(A), when the optical information is recorded on the outer peripheral side (on the left side of FIG. 4) of the recording medium 111 or the optical information is reproduced from the outer peripheral side of the recording medium 111, there are conjugate relationships between the display surface 101a of the spatial light modulator 101 (an incident plane 101a of the photodetector 101) and the entrance pupil plane 109a of the objective lens 109 (an exit pupil plane 109a of the objective lens 109) (the position of a mirror 107 in FIG. 4(A)), thus forming an image at both positions. Therefore, it is necessary to set the positional relations between the display surface 101a (the incident plane 101a), a first relay lens 103, the focal point f of a pair of relay lenses 103, 105, the second relay lens 105 and the entrance pupil plane 109a (the exit pupil plane 109a), to have the interval of the first focal distance f1, respectively. The terms and reference numerals for reproduction are noted after the terms and reference numerals for recording following “(xxx)”, which is also true in the followings.

As shown in FIG. 4(B), when the positions of the spatial light modulator 101 (the detecting means 101) is fixed and the position of the objective lens 109 is moved to the inner periphery side (on the right side of FIG. 4) of the recording medium 111, there are conjugate relationships between the display surface 101a of the spatial light modulator 101 (the incident plane 101a of the photodetector 101) and the entrance pupil plane 109a of the objective lens 109 (the exit pupil plane 109a of the objective lens 109) (the position of the mirror 107 in FIG. 4(A)). Thus, in order to form an image at both positions, it is necessary to set the positional relationships between each of the above-described members to have the interval of a second focal distance f2, respectively.

As described above, in order to form an image on the display surface 101a (incident plane 101a) and the entrance pupil plane 109a (the exit pupil plane 109a) on both the outer peripheral side and the inner peripheral side of the recording medium 111, it is necessary to change the focal distance (thickness) of a pair of the relay lenses 103,105. Therefore, it is considered that the structure of moving only the objective lens, which is employed conventionally for the CD drive and DVD drive, cannot be employed for the holographic recording, so that the optical system from the spatial light modulator 101 (the photodetector 101) to the objective lens 109 are moved as an unit.

In view of the above-described points, it is an object of the present invention to lighten the moving unit of an optical pickup device for making it accessible to a recording medium at a high speed so as to improve the transfer rate and to downsize a the driving means and, as a result, to downsize an optical information recording apparatus and an optical information reproducing apparatus.

### SUMMARY OF THE INVENTION

In order to achieve the aforementioned object, the optical information recording apparatus is an optical information recording apparatus utilizing holography, which comprises: a light source, a spatial light modulator for generating information light carrying information in light from the light source, a reference light generating means for generating reference light from the light from the light source, and an objective lens for irradiating the information light and the reference light to a recording medium, a pair of relay lenses which are disposed between the spatial light modulator and the objective lens, a pair of reflectors whose reflective planes mutually-perpendicular, which are disposed between a pair of the relay lenses, a first moving unit which, having the objective lens and a relay lens on the objective lens side of a pair of the relay lenses as a unit, moves to an irradiation position of the recording medium, and a second moving unit which having said pair of the reflectors as a unit.

Further, it is characterized that the above-described optical information recording apparatus comprises a control means for controlling movements of the first and second moving units, wherein the control means moves the first moving unit while moving the second moving unit by a half-distance of moving distance of the first moving unit in the same direction as that of the first moving unit.

In order to achieve the aforementioned object, the optical information reproducing apparatus of the present invention is an optical information recording apparatus utilizing holography, which comprises; a light source, a reference light generating means for generating reference light from light from the light source, an objective lens which irradiates the reference light to a recording medium and to which reproduction light generated from the recording medium makes incidence, and a detecting means for detecting the reproduction light, a pair of relay lenses which are disposed between the objective lens and the detecting means, a pair of reflectors whose reflective planes mutually-perpendicular, which are disposed between a pair of the relay lenses, a first moving unit, moves the objective lens and a relay lens on the objective lens side of a pair of the relay lenses to an irradiation position of the recording medium, and a second moving unit which having a pair of the reflectors as a unit.

Further, it is characterized that the above-described optical information reproducing apparatus comprises a control means for controlling movements of the first and second moving units, wherein the control means moves the first moving unit while moving the second moving unit by a half-distance of moving distance of the first moving unit in the same direction as that of the first moving unit.

### BRIEF DESCRIPTION OF THE DRAWINGS

FIG. 1 is a schematic diagram of an optical information recording/reproducing apparatus of the embodiment.

FIG. 2 is a schematic plan view for showing a pickup of the optical information recording/reproducing apparatus according to the present invention.

FIG. 3 is an illustration for showing the state where the irradiation position of the pickup of FIG. 2 is moved.

FIG. 4(A) and FIG. 4 (B) are illustrations for describing the tasks of the present invention.

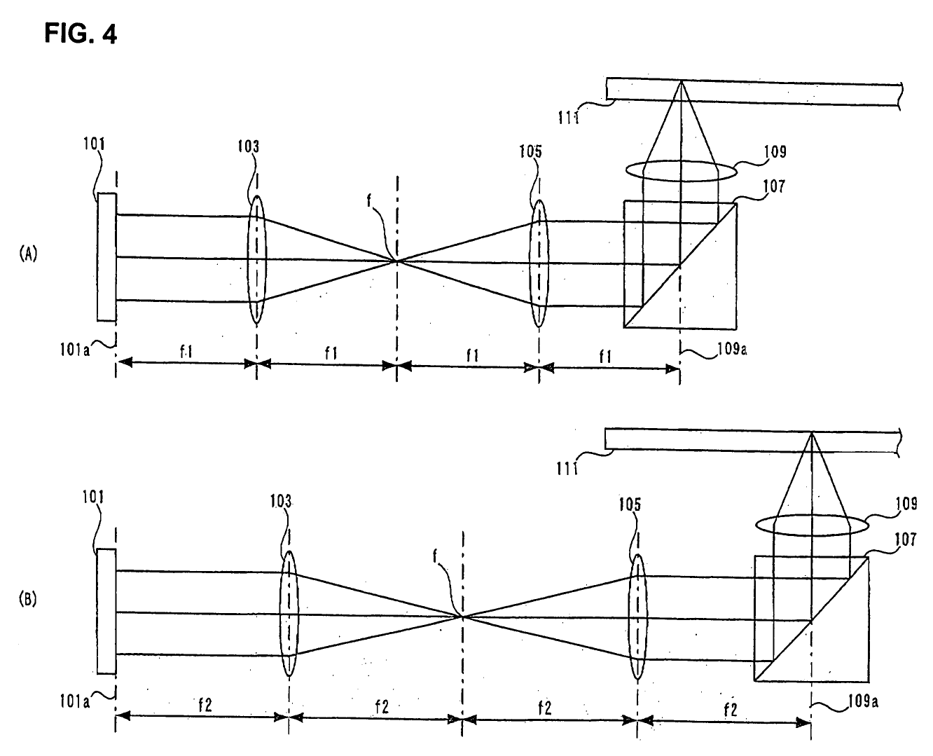

### DETAILED DESCRIPTION OF THE INVENTION

The optical information recording apparatus of the present invention comprises a pair of relay lenses which are disposed between the spatial light modulator and the objective lens, a pair of reflectors whose reflective planes mutually-perpendicular, which are disposed between a pair of the relay lenses, a first moving unit which, having the objective lens and a relay lens on the objective lens side of a pair of the relay lenses as a unit, moves to an irradiation position of the recording medium, and a second moving unit which having a pair of the reflectors as a unit. Thus, it is possible to change the relative positional relationship of the objective lens while keeping the distance between a pair of the relay lenses constant. Therefore, in the optical information recording apparatus of the present invention, it is possible to slide to a prescribed irradiation position of the recording medium by moving not the entire pickup but the first and second moving units. The part of the optical pickup device to be moved becomes lightened so that the driving means can be downsized and the optical information recording apparatus can be downsized as well. In addition, since the part of the optical pickup device to be moved is lightened, it is possible to access to the recording medium at a high speed thus enabling to improve the transfer rate.

The optical information reproducing apparatus of the present invention comprises a pair of relay lenses which are disposed between the objective lens and the detecting means, a pair of reflectors whose reflective planes mutually-perpendicular, which are disposed between a pair of the relay lenses, a first moving unit which, having the objective lens and a relay lens on the objective lens side out of a pair of the relay lenses as a unit, moves to an irradiation position of the recording medium, and a second moving unit which having a pair of the reflectors as a unit. Thus, it is possible to change the relative positional relationship of the objective lens while keeping the distance between a pair of the relay lenses constant. Therefore, in the optical information reproducing apparatus of the present invention, it is possible to slide to a prescribed irradiation position of the recording medium by moving not the entire pickup but the first and second moving units. The part of the optical pickup device to be moved becomes lightened so that the driving means can be downsized and the optical information recording apparatus can be downsized as well. In addition, since the part of the optical pickup device to be moved is lightened, it is possible to access to the recording medium at a high speed thus enabling to improve the transfer rate.

Preferred embodiments of the present invention will be described by referring to the drawings hereinafter.

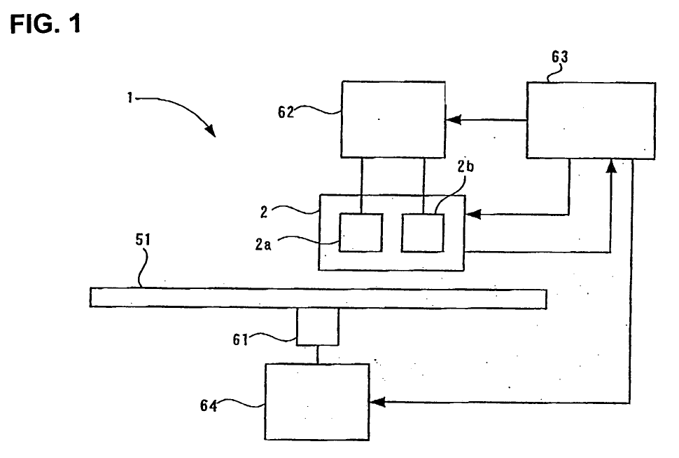

First, the overall structure of an optical information recording/reproducing apparatus 1 according to the embodiment will be described by referring to FIG. 1. The optical information recording/reproducing apparatus 1 comprises a mount section 61 to which a recording medium 51 is mounted, a pickup 2, a pickup driving means 62, and a control means 63.

The recording medium 51 comprises an information recording layer for recording holograms. In the case of the system in which a disc-type recording medium is used as the recording medium 51 that is rotated for performing recording/reproduction, a disc driving mechanism which is used for a CD drive and a DVD drive can be used. In addition, it is preferable since it becomes easy to have compatibility with the CD drive and the DVD drive. In this case, the optical information recording/reproducing apparatus 1 comprises a recording medium driving means 63 for rotating the recording medium 51 by driving the mount section 61, and the recording medium 64 is controlled by a control means 63 so as to keep the rotating speed of the recording medium 51 to a prescribed value.

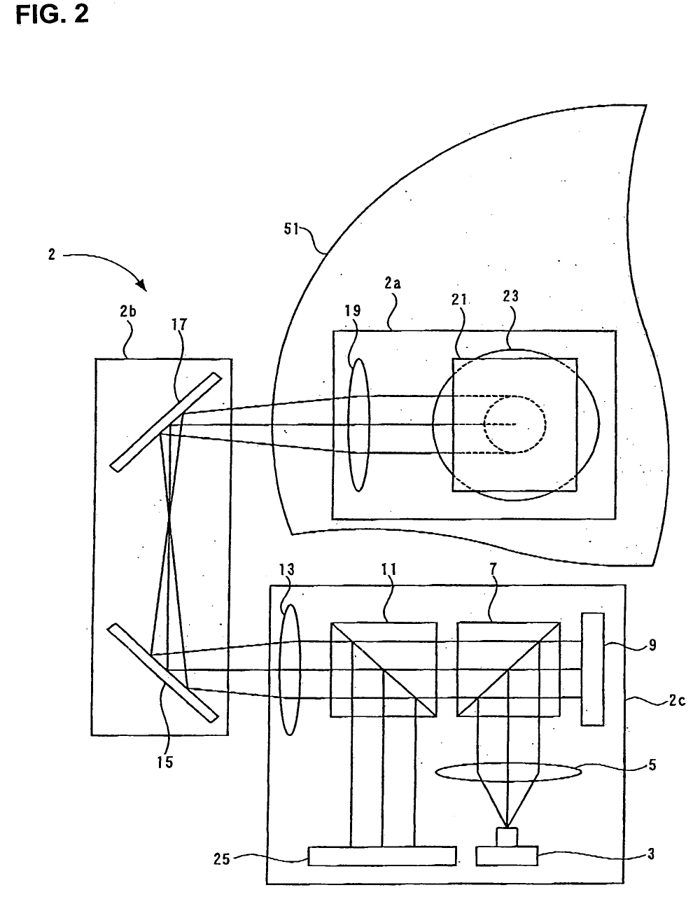

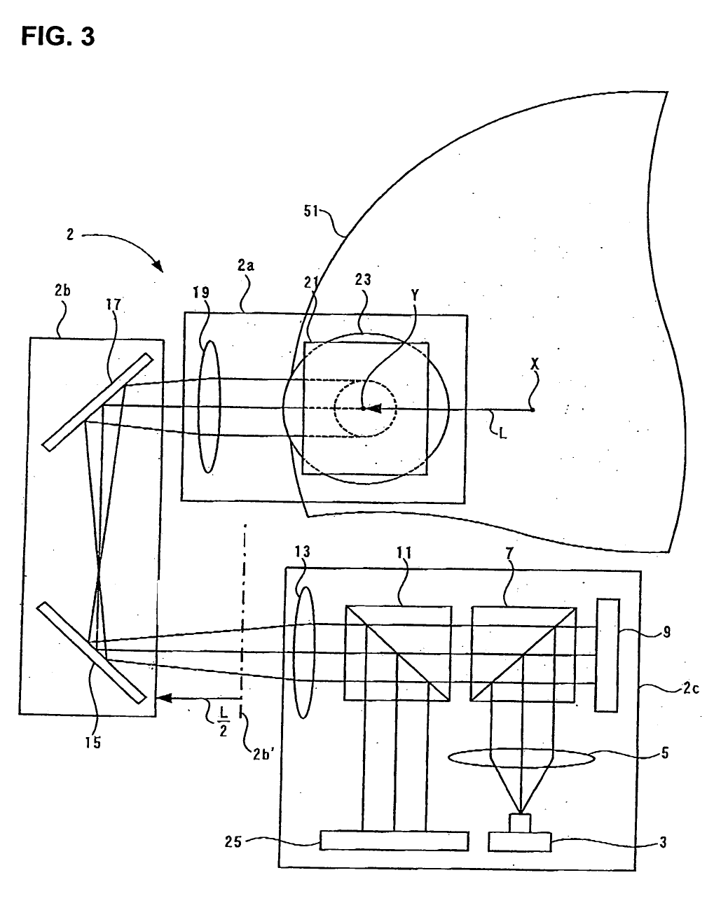

FIG. 2 and FIG. 3, which will be described later, illustrate a form of rotating the disc-type recording medium 51. However, the recording medium 51 is not limited to a disc type and the recording medium 51 may not be rotated. For example, the present invention can be applied to a case where a card-type recording medium 51 is used and a pickup is moved to a prescribed position.

Further, it is preferable to record information for determining the position in the recording medium 51 in advance and to employ a feedback mechanism for determining the position of the pickup 2 since it enables to perform more accurate positioning. Patent Document 1 describes this point in detail.

The pickup 2 is for recording information by irradiating the information light and the recording reference light to the recording medium 51 and for reproducing the information recorded in the recording medium 1 through detecting the reproduction light by irradiating the reproduction reference light to the recording medium 51. The pickup 2 comprises a first moving unit 2a which is movable to a recording position or a reproducing position of the recording medium 51 and a second moving unit 2b which moves in association with the movement of the first moving unit 2a.

The information reproduced by the pickup 2 from the recording medium 51 is transmitted to the control means 63 and decoded by a signal processing function of the control mans 63. Further, when the pickup 2 is provided with a function of reading out the information for determining the position of the recording medium 51, the information for determining the position, which is obtained by the pickup 2 from the recording medium 51, is transmitted to the control means 63. Shift in the position is detected by a detecting function of the control means 63, which is fed back to a pickup driving means 62 or an actuator inside the pickup 2. The actuator within the pickup 2 is a mechanism which slightly moves not the pickup 2 itself but an optical element such as an objective lens within the pickup 2 in order to perform focus servo for focusing the objective lens or tracking servo for achieving fine alignment of track position.

The pickup driving means 62 may have an individual means for driving each of the first moving unit 2a and the second moving unit 2b or partially common means. As will be described later, the first moving unit 2a and the second moving unit 2b have the same moving shaft so that it is possible to use a part of the pickup driving means 62 in common. It is preferable to commonly use the parts since it is effective for downsizing and lightening of the weight and enabling to cut the manufacturing cost as well. As the pickup driving means 62, for example, a linear motor can be used.

The control mean 63 comprises a CPU (central processing unit), a ROM (read-only-memory), and a RAM (random-access-memory) wherein the CPU executes a program stored in the ROM having the RAM as a work area for achieving the functions of the control means 63. The control means 63 controls the pickup driving means 62 so as to control the movements of the first moving unit 2a and the second moving unit 2b of the pickup. Furthermore, the information to be recorded is encoded by the signal processing function, which is transmitted to a spatial light modulator of the pickup 2, so that the information is recorded to the recording medium 51 by the pickup 2.

FIG. 2 shows a schematic plan view of the pickup 2 of the optical information recording/reproducing apparatus according to the present invention, and FIG. 3 is an illustration for showing the state where the irradiation position of the pickup 2 in FIG. 2 is moved. As shown in FIG. 2 and FIG. 3, the pickup 2 of the present invention comprises a recording/reproducing light source 3, a collimator lens 5, a first polarizing beam splitter 7, a spatial light modulator 9, a second polarizing beam splitter 11, a first relay lens 13, a pair of reflectors 15, 17, a second relay lens 19, a mirror 21, an objective lens 23, and a detecting means 25.

In addition, there are provided a first moving unit 2a which, as a unit, moves the objective lens 23, the mirror 21, and the second relay lens 19, and a second moving unit 2b which, as a unit, moves a pair of the reflectors 15, 17. In this embodiment, other members of the pickup 2 are collectively referred to as a fixed part 2c.

As the recording/reproducing light source 3, it is possible to use the one which generates light ray flux of coherent liner polarized light such as a semiconductor laser. For the recording/reproducing light source 3, the one with a short wavelength is advantageous for performing high-density recording so that it is preferable to employ a blue laser or a green laser.

The collimator lens 5 turns the light ray flux dispersed from the recording/reproducing light source 3 into almost the parallel light rays. The first polarizing beam splitter 7 comprises a half reflector plane which reflects or transmits the linear polarized light (for example, P-polarized light) and transmits or reflects the linear polarized light (for example, S-polarized light) which is perpendicular to the above-mentioned polarized light. In FIG. 2, the first polarizing beam splitter 7 reflects the light ray flux generated from the recording/reproducing light source 3 towards the spatial light modulator 9 and transmits the information light and the recording reference light whose polarization directions are rotated by 90° by the spatial light modulator 9.

The spatial light modulator 9 can use a transmission-type or reflection-type spatial light modulator having a great number of pixels arranged in lattice form, which is capable of modulating the phase and/or intensity of the emission light by each pixel. As the spatial light modulator, a DMD (digital-micromirror-device) or a matrix-type liquid crystal element can be used. The DMD can modulate the intensity of the incident light by changing the reflecting direction by each pixel and spatially modulate the phase of the incident light by changing the reflecting position by each pixel. The liquid crystal element can spatially modulate the intensity and the phase of the incident light by controlling the orientation state of the liquid crystals by each pixel. For example, through setting the phases of the emitted light by each pixel to be either one of two values which differ by π (pi) radian from each other, the phase of the light can be spatially modulated. The spatial light modulator, in addition, rotates the polarization direction of the emitted light by 90° with respect to the polarization direction of the incident light.

Through spatially modulating the light from the light source 3 by the two-dimensional digital pattern information which is displayed on a display surface of the spatial light modulator 9, the information light carrying the two-dimensional digital pattern information can be generated.

Further, in FIG. 2, the spatial light modulator 9 also functions as a reference light generating means which generates recording reference light from the light source at the time of recording and reproduction reference light at the time of reproduction. As shown in FIG. 2, in the case of generating the information light and the reference light by a single spatial light modulator, there may be provided two areas in the spatial light modulator so as to form the information light in one area and the reference light in the other area.

The reference light generating means may be provided separately from the spatial light modulator 9. For example, the light from the light source 3 may be divided so that the information light is generated from one of the light by the spatial light modulator 9 and the reference light from the other light. In this case, an optical system for propagating the other light, which includes an optical element for dividing the light from the light source 3, serves as the reference light generating means.

Furthermore, the reference light may be spatially modulated by providing another spatial light modulator in the optical system which propagates the other light. In this case, like the information light, it is necessary to form an image of the two-dimensional digital pattern information of the reference light on the entrance pupil plane of the objective lens 23. Therefore, the spatial light modulator for generating the information light and the spatial light modulator for generating the reference light are to be in a conjugate relationship for achieving propagation by a pair of relay lenses.

The second polarizing beam splitter 11, at the time of reproduction, transmits the reproduction reference light and reflects the reproduction light which is generated from the recording medium 51 by the reference light towards the detecting means 25.

The first and second relay lenses 13, 19 are disposed between the spatial light modulator 9 and the objective lens 23 so as to form an image displayed in the spatial light modulator 9 on the entrance pupil plane of the objective lens 23. That is, they are disposed in such a manner that the distance from the spatial light modulator 9 to the first relay lens 13 becomes the focal distance f1 of the first relay lens 13, the distance from the second relay lens 19 to the entrance pupil plane of the objective lens 23 becomes the focal distance f2 of the second relay lens 19, and the distance between the first and second relay lenses 13, 19 becomes the sum of the focal distance f1 of the first relay lens 13 and the focal distance f2 of the second relay lens 19.

Further, in FIG. 2, the first and second relay lenses 13, 19 are disposed between the objective lens 23 and the detecting means 25 so as to form the image on the exit pupil plane of the objective lens 23, which is of the reproduction light generated from an information recording layer of the recording medium by the reproduction reference light, again as a real image. That is, they are disposed in such a manner that the distance from the exit pupil plane of the objective lens to the second relay lens 19 becomes the focal distance f2, the distance from the first relay lens 13 to the detecting means 25 becomes the focal distance f1, and the distance between the first and second relay lenses 13, 19 becomes the sum of the focal distance f1 and the focal distance f2.

The positions of the above-described pair of relay lenses 13, 19 are to change when other optical elements are disposed as appropriate. For example, when a magnifying lens is disposed between the first relay lens 13 and the detecting means 25, it is arranged in such a manner that the distance between the first relay lens and the entrance pupil plane of the magnifying lens becomes the focal distance f1.

A pair of the reflectors 15 and 17 are disposed between a pair of the relay lenses 13, 19 in such a manner that the reflecting planes of the both become orthogonal. Thus, by a pair of the reflectors 15, 17, the light is propagated between a pair of the relay lenses 13, 19 which are arranged in parallel. That is, the first reflector 15 reflects the light from the first relay lens 13 towards the second reflector 17, and the second reflector 17 reflects the light from the first reflector 15 towards the second relay lens 19. As the reflectors 15, 17, there is no specific limitation as long as they can change the traveling direction of the light, and it is possible to use a mirror, prism, etc.

The mirror 21 is for reflecting the light from the second relay lens 19 towards the objective les 23. Further, there is a quarter wavelength plate, not shown, disposed between the mirror 21 and the objective lens 23. The quarter wavelength plate is a phase plate which changes, by quarter wavelength, the difference of the optical paths of the polarized light which oscillates in the directions vertical to each other. The P-polarized light is changed into a circularly polarized light by the quarter wavelength plate and, further, the circularly polarized light is changed into the S-polarized light when passing through the quarter wavelength plate. By the quarter wavelength plate, the reproduction reference light and the reproduction light at the time of reproduction can be separated by the second polarizing beam splitter 11.

The objective lens 23, at the time of recording, irradiates the information light and reference light formed on the entrance pupil plane to the recording medium 51 for causing interference in the information recording layer to achieve recording. Further, at the time of reproduction, it irradiates the reference light formed on the entrance pupil plane to the recording medium 51 and form an image on the exit pupil plane by receiving the reproduction light which is generated from the recording medium 51.

The detecting means 25 comprises a great number of pixels arranged in lattice form, which makes it possible to detect the intensity of the received light by each pixel. As the photodetector 25, a CCD-type solid image pickup device or a MOS-type solid image pickup device can be used. Further, as the photodetector 25, a smart optical sensor (for example, see a literature “O pulse E, September 1996, No. 202, pp. 93-99”) may be used, in which a MOS-type image pickup device and a signal processing circuit are integrated on a single chip. This smart optical sensor has a large transfer rate and a high-speed operating function. Thus, use of this smart optical sensor enables to achieve a high-speed reproduction so that it becomes possible to perform reproduction by, for example, a transfer rate in order of G (giga) bit/second.

The first moving unit 2a comprises at least the objective lens 23 and the second relay lens 19, which can be moved, as a unit, to a recording position or a reproduction position of the recording medium 51 by the pickup driving means 62. In FIG. 2, the mirror 21, the quarter wavelength plate, and the objective lens 23 after the second relay lens 19 are moved and slid as a unit as the first moving unit 2a.

The second moving unit 2b comprises at least a pair of the reflectors 14, 17, which is moved by the pickup driving means 62 in association with the movement of the first moving unit 2a. The second moving unit 2b is for keeping the distance from the first relay lens 13 to the second relay lens 19 constant even if the first moving unit 2a slides, so that relative positional relationship between the first relay lens 13 changes.

Next, recording action of the recording/reproducing apparatus 1 shown in FIG. 1 and FIG. 2 will be described. The light emitted from the light source 3 is made parallel by the collimator lens 5, and the parallel light is reflected by the first polarizing beam splitter 7 towards the spatial light modulator 9. The parallel light becomes the information light and the recording reference light by the two-dimensional digital pattern information expressed by the spatial light modulator 9. The information light and the recording reference light is propagated by a pair of relay lenses 13 and 19 so as to form an image of the two-dimensional digital pattern information, which is expressed by the spatial light modulator 9, on the entrance pupil plane of the objective lens 23. On the way, the light is reflected by a pair of the reflectors 14, 17, which is then reflected by the mirror 21 towards the objective lens 23 and passes through the quarter wavelength plate (not shown). Then, it is irradiated to the recording medium 51 by the objective lens 23 so as to record the interference pattern of the information light and the recording reference light in the information recording layer of the recording medium 51.

Described by referring to FIG. 3 is a case where the irradiation position of the recording apparatus 1 is changed. FIG. 3 shows the state where the first moving unit 2a is moved by the pickup driving means 64 from the irradiation position X of FIG. 2 by a distance L in the left direction of the drawing until the irradiation position Y on the outer peripheral side of the recording medium 51. At this time, the second moving unit 2b is also moved by the pickup driving means 64 from the position 2b′ (a part of which is shown by an alternate long and short line in FIG. 3) of FIG. 2 by a distance L/2 in the same direction (in the left direction of the drawing) as that of the moving direction of the first moving unit 2a. Therefore, it is possible to change the irradiation position of the recording medium 51 without changing the distance between the first relay lens 13 and the second relay lens 19.

In other words, when the first moving unit 2a moves in the left direction of the drawing for the distance L, the distance between the first moving unit 2a and the second moving unit 2b is shortened by the distance L. However, the second moving unit 2b moves in the same direction for the distance L/2 so that the distance between the second moving unit 2b and the first moving unit 2a is extended by the distance L/2. Thus, the distance between the second moving unit 2b and the fixed part 2c is extended by the distance L/2. As a result, there is no change in the distance from the first moving unit 2a to the fixed part 2c through the second moving unit 2b, which can be expressed as (−L)+(L/2)+(L/2)=0. Accordingly, there is no change in the distance between the second relay lens 19 of the first moving unit 2a and the first relay lens 13 of the fixed part 2c.

It is the same even when moved in the reverse direction. If the first moving unit 2a is moved in the right direction of the drawing by the distance L, the distance between the first moving unit 2a and the second moving unit 2b is extended by the distance L. However, the second moving unit 2b moves in the same direction for the distance L/2 so that the distance between the second moving unit 2b and the first moving unit 2a is shortened by the length L/2. Thus, the distance between the second moving unit 2b and the fixed part 2c is shortened by the distance L/2. As a result, there is no change in the distance from the first moving unit 2a to the fixed part 2c through the second moving unit 2b, which can be expressed as (L)+(−L/2)+L/2)=0.

As described above, in the position of FIG. 3, it is possible to form the image of the two-dimensional digital pattern information, which is displayed by the spatial light modulator 9, on the entrance pupil plane of the objective lens 23 so that holographic recording can be performed.

Furthermore, reproducing action of the recording/reproducing apparatus which is shown in FIG. 1 and FIG. 2 will be described. The light emitted from the light source 3 is made parallel by the collimator lens 5, and the parallel light is reflected by the first polarizing beam splitter 7 towards the spatial light modulator 9. The reproduction reference light is generated by the two-dimensional digital pattern information expressed by the spatial light modulator 9. The reproduction reference light transmits through the second polarizing beam splitter 11 and is propagated by a pair of the relay lenses 13, 19 so as to form an image of the two-dimensional digital pattern information, which is expressed by the spatial light modulator 9, on the entrance pupil plane of the objective lens 23. On the way, the light is reflected by a pair of the reflectors 14, 17, which is then reflected by the mirror 21 towards the objective lens 23 and passes through the quarter wavelength plate (not shown). Then, it is irradiated to the recording medium 51 by the objective lens 23 and generates the reproduction light by interfering with the interference pattern recorded in the information recording layer of the recording medium 51.

The reproduction light is reflected by the reflector layer of the recording medium 51 and emitted from the recording medium 51 towards the objective lens 23. The two-dimensional digital pattern information of the reproduction light is reproduced on the exit pupil plane, which is propagated by a pair of the relay lens 13, 19 so as to form an image on the detecting means 25. On the way, it passes through the quarter wavelength plate, is reflected by the mirror 21 towards a pair of the relay lenses 13, 19, reflected by a pair of reflectors 14, 17, and reflected by the polarizing beam splitter 11. Then, the two-dimensional digital pattern information of the reproduction light is reflected by the detecting means 25 for reproducing the information.

Described by referring to FIG. 3 is a case where the irradiation position of the recording apparatus 1 is changed. As shown in FIG. 3, the position of the first moving unit 2a is moved by the pickup driving means 64 from the irradiation position X of FIG. 2 by a distance L in the left direction of the drawing until the irradiation position Y on the outer peripheral side of the recording medium 51. At this time, the position of the second moving unit 2b is also moved by the pickup driving means 64 by a distance L/2 in the same direction as that of the moving direction of the first moving unit 2a. With this, as described above, it is possible to change the irradiation position of the recording medium 51 without changing the distance between the first relay lens 13 and the second relay lens 19.

Therefore, at the position of FIG. 3, it is also possible to form the image of the two-dimensional digital pattern information of the reference light, which is displayed by the spatial light modulator 9, on the entrance pupil plane of the objective lens 23. Thus, the image of the reproduction light which is reproduced on the exit pupil plane of the objective lens 23 can be detected by the detecting means so that reproduction of the holographic recording can be performed.

In the present invention, it is preferable to have a set 2c of the members other than the pickup 2 as a fixed part in terms of simplifying the structure and of the transfer rate. However, it is not limited to be the fixed part. Even in the case where the set 2c is a third moving unit, it is possible to change the relative positional relationship, while keeping the distance between the first relay lens and the second relay lens constant by controlling to satisfy x−2y+z=0 (reverse the signs of the moving distance when the moving direction is reversed), where the moving distance of the first moving unit 2a is x, the moving distance of the second moving unit 2b is y, and the moving distance of the third moving unit 2c is z.

The present invention is not limited to the above-described embodiment but various modifications are possible as necessary. For example, it can be used as an optical information recording apparatus by using only the part to be used for recording among the optical information recording/reproducing apparatus according to the above-described embodiment, and it can be used as an optical information reproducing apparatus by using only the part to be used for reproduction.

What is claimed is:

1. An optical information recording apparatus utilizing holography, comprising;
a light source,
a spatial light modulator to generate information light carrying information in light from said light source, a reference light generating means for generating reference light from said light from said light source, and an objective lens for irradiating said information light and said reference light to a recording medium,
a pair of relay lenses which are disposed between said spatial light modulator and said objective lens,
a pair of reflectors whose reflective planes mutually-perpendicular, which are disposed between said pair of relay lenses,
a first moving unit which having said objective lens and a relay lens on said objective lens side of said pair of relay lenses as a unit, moves to an irradiation position of said recording medium, and
a second moving unit which having said pair of reflectors as a unit.

2. The optical information recording apparatus according to claim 1, further comprising;
said optical information recording apparatus having a control means for controlling movements of said first and second moving units,
wherein said control means moves said first moving unit while moving said second moving unit by a half-distance of moving distance of said first moving unit in a same direction as that of said first moving unit.

3. An optical information reproducing apparatus utilizing holography, comprising;
a light source, a reference light generating means for generating reference light from light from said light source,
an objective lens which irradiates said reference light to a recording medium and to which reproduction light generated from said recording medium makes incidence,
a detecting means for detecting said reproduction light,
a pair of relay lenses which are disposed between said objective lens and said detecting means,
a pair of reflectors whose reflective planes mutually-perpendicular, which are disposed between said pair of relay lenses,
a first moving unit moves said objective lens and a relay lens on said objective lens side of said pair of relay lenses to an irradiation position of said recording medium, and
a second moving unit which having said pair of reflectors as a unit.

4. The optical information reproducing apparatus according to claim 3, further comprising
said optical information recording apparatus having a control means for controlling movements of said first and second moving units,
wherein, said control means moves said first moving unit while moving said second moving unit by a half-distance of moving distance of said first moving unit in a same direction as that of said first moving unit.
